(19) United States
(12) Patent Application Publication
(10) Pub. No.: US 2012/0266186 A1
(43) Pub. Date: Oct. 18, 2012

(54) PROVIDING INTER-PLATFORM APPLICATION LAUNCH IN CONTEXT

(75) Inventors: Kenneth James Parzygnat, Apex, NC (US); Christopher Johan Schaubach, Cary, NC (US)

(73) Assignee: INTERNATIONAL BUSINESS MACHINES CORPORATION, Armonk, NY (US)

(21) Appl. No.: 13/084,639

(22) Filed: Apr. 12, 2011

(51) Int. Cl. G06F 9/46

(52) U.S. Cl. 719/320

(57) ABSTRACT

A method for providing inter-platform application launch comprises receiving a query from a first application, the query comprising one or more attributes of a resource; comparing the one or more resource attributes to a central registry, the central registry comprising a plurality of application launch points, the central registry being accessible from a plurality of different applications on a plurality of different platforms; identifying one or more application launch points that match the query; and returning a launch instruction for each of the one or more matching application launch points.

### BACKGROUND

The present invention relates to launch-in-context of applications.

In an enterprise, products may not be as integrated as would be desirable. There are several aspects to integration, and one of those aspects is an ability known as launch-in-context. Launch-in-context provides the ability for one product to launch to another and pass information allowing the launched application to start at an expected starting point. A simple example of a launch in context is capability found in several file browser applications. In such file browser applications, a user can right click on a document, then select “Open with . . . ” to see possible launch points. This is accomplished using a local registry that applications register themselves in when they are installed on the platform, thereby allowing any of the applications on that platform to launch to another application on that platform.

### BRIEF SUMMARY

In one embodiment of the invention, a method for providing inter-platform application launch comprises (a) receiving a query from a first application, the query comprising one or more attributes of a resource; (b) comparing the one or more resource attributes to a central registry, the central registry comprising a plurality of application launch points, the central registry being accessible from a plurality of different applications on a plurality of different platforms; (c) identifying one or more application launch points that match the query; and (d) returning a launch instruction for each of the one or more matching application launch points.

In addition to the method for providing inter-platform application launch, as described above, other aspects of the present invention are directed to corresponding systems for providing inter-platform application launch and computer program products for providing inter-platform application launch.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system for providing inter-platform application launch, in accordance with an embodiment of the present invention;

FIG. 2 is a flowchart of a method of providing inter-platform application launch, in accordance with an embodiment of the present invention;

FIG. 3 is a schematic block diagram of a computer network in which embodiments of the present invention may operate; and

FIG. 4 is a schematic block diagram of a computer in the network of FIG. 3.

### DETAILED DESCRIPTION

One shortcoming of current launch-in-context implementations is that there may be an application (or multiple applications) stored on another platform or system (or multiple platforms or systems) that might be desirable to use. However, since those applications are not stored directly on the same system as the application that might desire to use them, they cannot be discovered as a possible launch target.

Embodiments of the invention may provide the ability for applications (termed “launching applications”) to become aware of other applications (termed “target applications”) on other platforms and launch one or more of the other (target) applications when appropriate. Some applications may, at different times, be either a launching or a target application. Embodiments of the invention allow multiple different applications on multiple different platforms to register launch points into a central registry. That central registry may be separate from the platforms on which the launching and target applications reside, or the central registry may co-reside on a platform with one or more of the launching and/or target applications. Applications from multiple platforms can register their launch points to this central registry which will allow any application from any platform that can access the central registry to find the launch points.

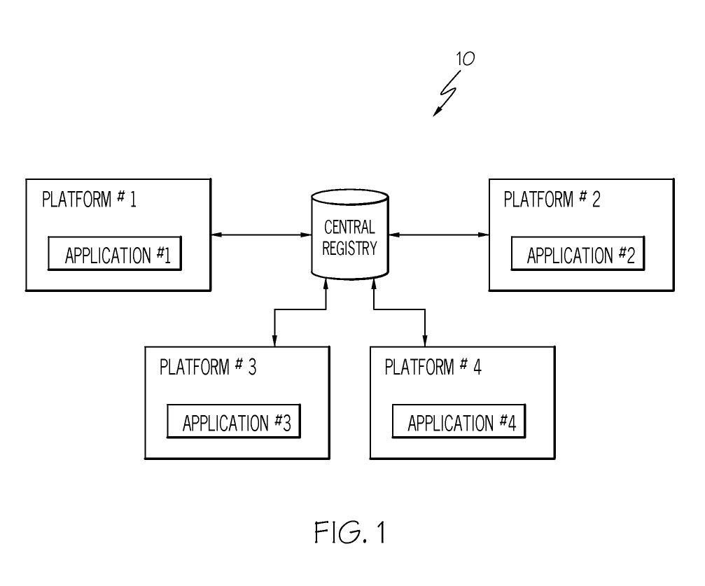

Referring now to FIG. 1, a schematic block diagram of a system 10 for providing inter-platform application launch is illustrated in accordance with an embodiment of the present invention. The system 10 comprises a central registry for receiving and storing launch points from a plurality of applications. A plurality of different platforms may be communicatively connected (such as via a network, as discussed in more detail below) to the central registry. Each of the different platforms may host one or more applications (which may be launching applications, target applications, or a combination thereof). For example, FIG. 1 illustrates four different platforms upon each of which one application resides. Application #1 resides on Platform #1; Application #2 resides on Platform #2; Application #3 resides on Platform #3; and Application #4 resides on Platform #4. Each of the applications illustrated in FIG. 1 may be a launching application, a target application, or either a launching application or a target application at different times. While FIG. 1 illustrates one application residing on each of the four platforms, any number of platforms may be connected to the central registry and any number of applications may reside on each of the platforms.

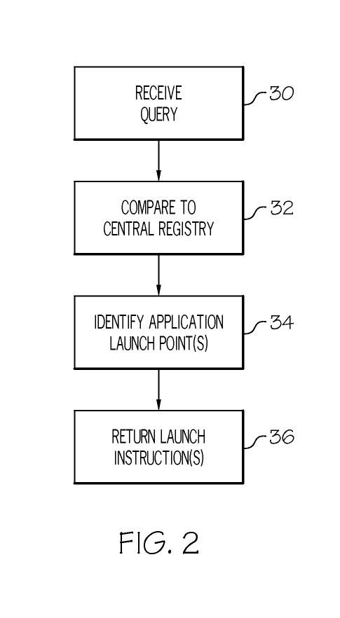

Referring now to FIG. 2, a flowchart of a method of providing inter-platform application launch is illustrated in accordance with an embodiment of the present invention. Each launch point in the central registry is associated with a filter. The filter allows the launching application to decide which launch types are valid for a given resource. Each application or platform can interface to the registry by using, for example, a common component such as a set of Java classes or through a web based interface (which may, for example, be accessed using representational state transfer (REST). When an application wants to find launch points, the application calls the Java interface, passing attributes about the resource to the central registry (this passing of attributes is termed a “query” herein). The query is received by the central registry (block 30), and the filter then compares the attributes to the registered launch points in the central registry (block 32). The launch points that match are identified (block 34) and the launch instruction(s) corresponding to the matching launch point(s) is/are returned to the launching application (block 36). Now the launching application on its platform can launch to another application on another platform. In such a scenario, the target application must be able to run remotely (for example, the target application can be a Web-based application).

As an example of the process of embodiments of the invention illustrated in FIG. 2, assume the “resources” are computer systems and a user interface (UI) displays a list of these computer systems. Further assume one of the computer systems in the list has the following known attributes:

IPAddress = 9.27.5.5
Hostname = credit432.raleigh.ibm.com
ConfigID = xyz
ClassType = ComputerSystem.

Further assume that three applications on different platforms have registered launch points in the central registry. The launch points have the following elements:

```
Entry 1 (a launch point that can give change details about a computer
system):
    Filter: ConfigID={.*}
    Parameter1: id={ConfigID}
    URL: http://www.ccmdb.com/
Entry 2 (a launch point that can show business services related to a
computer system):
    Filter: ClassType=ComputerSystem && Hostname={credit.*}
    Parameter1: host={Hostname}
    Parameter2: ip={IPAddress}
    URL: http://www.tbsm.com/
Entry 3 (a launch point that can show weather conditions based on a
GPS coordinate):
    Filter: GPSCoordinate={.*}
    Parameter1: coord={GPSCoordinate}
    URL: http://www.getweather.com/
```

When a user performs an action (such as right mouse click) to find launch points that match for the resource defined above, the launching application will query the registry by sending the resource attributes to the central registry. The central registry will compare the resource attributes to the launch points in the central registry and identify launch points whose filters match the set of attributes for the resource. In this example, the attributes are expressed as name value pairs as shown above. The filter for each entry in the central registry is examined to see if the set of attributes from the resource satisfy the filter for that entry. The filter may use Boolean operators (e.g., AND and OR) to determine if all, just one, or some combination of the attributes of the query need to match for the launch point to be determined to be a match.

In this example, Entry 1 is satisfied. The { } brackets around the value indicate a regular expression, and {.*} in the filter of Entry 1 means match anything. Since there is a ConfigID attribute, this matches. Entry 2 is satisfied. The ClassType value “ComputerSystem” in the filter of Entry 2 matches the ClassType attribute “ComputerSystem” of the resource. Additionally, the Hostname of the resource starts with “credit” which matches the filter for Entry 2. Entry 3 is not satisfied, as there is no attribute called “GPSCoordinate” for this resource.

The central registry returns launch instructions to the querying application for each of the matching launch points. In the example (in which the target applications are Web-based applications), what gets returned are launch URLs with the parameters defined in the central registry entry filled in. The { } brackets in the parameter specification imply that a substitution with the value for that attribute should occur. Remember the launch entry was defined/registered by the target application. As such, Entry 1 will return a launch URL of: http://www.ccmdb.com/?id=xyz and Entry 2 will return a launch URL of http://www.tbsm.com/?host=credit432.raleigh.ibm.com&ip=9.27.5.5. At this point, the querying application can now launch the URL and the specified action can be run.

Embodiments of the invention may enable users to make greater use of their resources, thereby saving money and time. Embodiments of the invention may enable only one copy of an application to be installed within a networked environment, thereby providing cost savings because there is no need to install multiple copies of the same application on multiple platforms. Embodiments of the invention may reduce configuration efforts because applications can go to a single store to register and lookup launch points, rather than having an administrator needing to configure each individual platform. Embodiments of the invention may enable resource savings because the application is consuming resources on only one system instead of consuming resources on multiple systems.

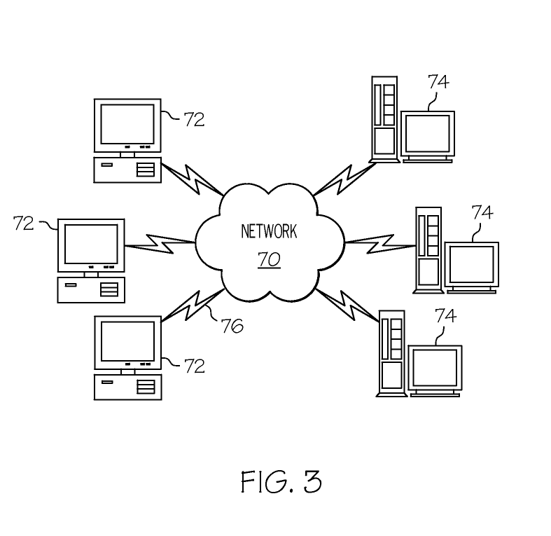

FIG. 3 is a schematic block diagram of a computer network in which embodiments of the present invention may operate. Computers 72 and servers 74 provide processing, storage, and input/output devices executing application programs and the like. Computers 72 may be linked over communication link 76 through communications network 70 to each other and to other computing devices, including servers 74. Communications network 70 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computers 72 and servers 74 may be linked over any suitable communication network. In the system of FIG. 3, the launching applications and the target applications may reside on any combination of computers 72 and servers 74.

In addition to the client-server arrangement of FIG. 3, embodiments of the invention may operate in any client-server arrangement or in any networked arrangement in which resources to be updated and tasks to perform the updating may reside on separate elements in a network. For example, embodiments of the invention may operate in a mobile communications/data architecture (such as a mobile telecommunications network adhering to the International Mobile Telecommunications-2000 (also termed 3G) or IMT-Advanced (also termed 4G) standards), in which a mobile telecommunications device (e.g., cell/mobile telephone) communicates.

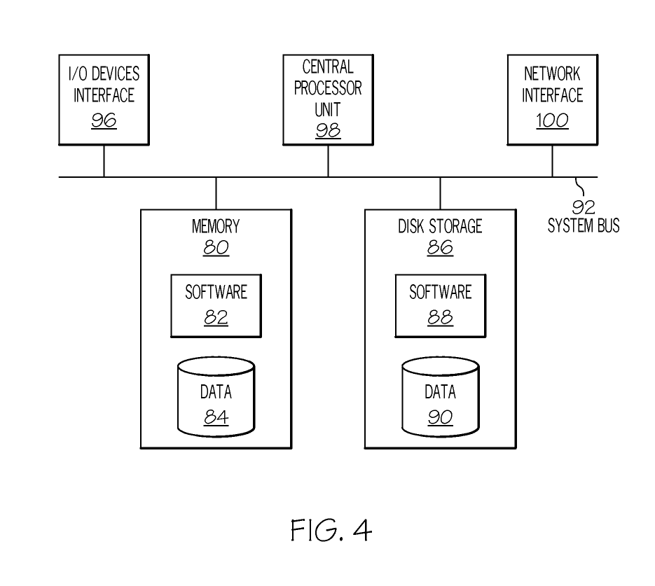

FIG. 4 is a diagram of one possible internal structure of a computer (e.g., computer 72) in the system of FIG. 3. Each computer typically contains system bus 92, where a bus is a set of hardware lines used for data transfer among the components of a computer. Bus 92 is essentially a shared conduit that connects different elements of a computer system (e.g., processor, disk storage, memory, input/output ports, network ports, etc.) that enables the transfer of information between the elements. Attached to system bus 92 is I/O device interface 96 for connecting various input and output devices (e.g., displays, printers, speakers, microphones, etc.) to the computer. Alternatively, the I/O devices may be connected via one or more I/O processors attached to system bus 92. Network interface 100 allows the computer to connect to various other devices attached to a network (e.g., network 70 of FIG. 3). Memory 80 provides volatile storage for computer software instructions 82 and data 84 used to implement an embodiment of the present invention. Disk storage 86 provides non-volatile storage for computer software instructions 88 and data 90 used to implement an embodiment of the present invention. Central processor unit 98 is also attached to system bus 92 and provides for the execution of computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. If the service is also available to applications as a REST interface, then launching applications could use a scripting language like JavaScript to access the REST interface. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method for providing inter-platform application launch, the method being implemented by a computer, the method comprising:
receiving a query from a first application, the query comprising one or more attributes of a resource;
comparing the one or more resource attributes to a central registry, the central registry comprising a plurality of application launch points, the central registry being accessible from a plurality of different applications on a plurality of different platforms;
identifying one or more application launch points that match the query; and
returning a launch instruction for each of the one or more matching application launch points.

2. The method of claim 1, wherein the plurality of application launch points in the central registry each comprise a filter defining one or more attributes for resource matching, and wherein identifying one or more application launch points that match the query comprises identifying one or more application launch points whose one or more attributes defined by its filter match one or more of the one or more attributes of the query.

3. The method of claim 1, wherein the plurality of application launch points in the central registry each comprise one or more launch parameters, and wherein each returned launch instruction comprises the one or more corresponding launch parameters.

4. The method of claim 1, wherein the plurality of application launch points in the central registry each comprise a launch uniform resource locator (URL), and wherein each returned launch instruction comprises the corresponding launch URL.

5. A system for providing inter-platform application launch comprising:
a processor configured for (a) receiving a query from a first application, the query comprising one or more attributes of a resource; (b) comparing the one or more resource attributes to a central registry, the central registry comprising a plurality of application launch points, the central registry being accessible from a plurality of different applications on a plurality of different platforms; (c) identifying one or more application launch points that match the query; and (d) returning a launch instruction for each of the one or more matching application launch points.

6. The system of claim 5, wherein the plurality of application launch points in the central registry each comprise a filter defining one or more attributes for resource matching, and wherein identifying one or more application launch points that match the query comprises identifying one or more application launch points whose one or more attributes defined by its filter match one or more of the one or more attributes of the query.

7. The system of claim 5, wherein the plurality of application launch points in the central registry each comprise one or more launch parameters, and wherein each returned launch instruction comprises the one or more corresponding launch parameters.

8. The system of claim 5, wherein the plurality of application launch points in the central registry each comprise a launch uniform resource locator (URL), and wherein each returned launch instruction comprises the corresponding launch URL.

9. A computer program product for providing inter-platform application launch, the computer program product comprising a computer readable storage medium having computer readable program code embodied therewith, the computer readable program code comprising:
computer readable program code configured for receiving a query from a first application, the query comprising one or more attributes of a resource;
computer readable program code configured for comparing the one or more resource attributes to a central registry, the central registry comprising a plurality of application launch points, the central registry being accessible from a plurality of different applications on a plurality of different platforms;
computer readable program code configured for identifying one or more application launch points that match the query; and
computer readable program code configured for returning a launch instruction for each of the one or more matching application launch points.

10. The computer program product of claim 9, wherein the plurality of application launch points in the central registry each comprise a filter defining one or more attributes for resource matching, and wherein identifying one or more application launch points that match the query comprises identifying one or more application launch points whose one or more attributes defined by its filter match one or more of the one or more attributes of the query.

11. The computer program product of claim 9, wherein the plurality of application launch points in the central registry each comprise one or more launch parameters, and wherein each returned launch instruction comprises the one or more corresponding launch parameters.

12. The computer program product of claim 9, wherein the plurality of application launch points in the central registry each comprise a launch uniform resource locator (URL), and wherein each returned launch instruction comprises the corresponding launch URL.
